(19) United States
(12) Patent Application Publication
(10) Pub. No.: US 2018/0112542 A1
(43) Pub. Date: Apr. 26, 2018

(54) GAS TURBINE ENGINE ROTOR

(71) Applicant: PRATT & WHITNEY CANADA CORP., Longueuil (CA)

(72) Inventors: Alain BOUTHILLIER, Ste-Julie (CA); Jean FOURNIER, Longueuil (CA); Michel FREDERICK, Candiac (CA)

(21) Appl. No.: 15/332,313

(22) Filed: Oct. 24, 2016

(51) Int. Cl. F01D 5/30

(52) U.S. Cl. CPC F01D 5/3007; F05D 2230/10

(57) ABSTRACT

A rotor for a gas turbine engine is described and includes a disc and a plurality of blades. The disc has opposite first and second end surfaces spaced apart by a peripheral surface circumferentially extending about the rotor, and a plurality of slots defined in the peripheral surface and each having a length extending between a first slot opening in the first end surface and a second slot opening in the second end surface. Each of the slots has a tapered shape with at least one dimension of a cross-sectional shape of the slot reducing along at least a portion of the length of the slot. The at least one dimension at the first slot opening is greater than the at least one dimension at the second slot opening. The blades having a complimentary root are received in the slots of the rotor.

### TECHNICAL FIELD

The application relates generally to rotors for a gas turbine engine, and more particularly to such rotors having blades removably mounted thereto.

### BACKGROUND

Gas turbine engine rotors, such as those used in compressors or turbine sections of the gas turbine engine, generally include a disc to which a plurality of blades is removably mounted. These blades typically have shaped roots that are received within correspondingly shaped slots in the periphery of the disc. The slots are typically open on each axial end of the disc. Accordingly, when a blade is received within the slot of the disc, it is axially slid into the slot from either the upstream or downstream side of the disc. Once in position, a fastener on each side of the disc is required in order to axially align the blades in the correct position and trap the blade roots within the slots of the disc.

### SUMMARY

In one aspect, there is provided a rotor for a gas turbine engine comprising a disc having opposite first and second end surfaces axially spaced apart by a peripheral surface circumferentially extending about the rotor, a plurality of slots defined in the peripheral surface and each having a length in an axial direction extending between a first slot opening in the first end surface and a second slot opening in the second end surface, each of the plurality of slots having a tapered shape with at least one dimension of a cross-sectional shape of the slot reducing along at least a portion of the length of the slot, wherein the at least one dimension at the first slot opening is greater than the at least one dimension at the second slot opening to define said tapered shape; and a plurality of blades each having a root received in a respective one of said slots, the root having a complimentary shape and size to said respective one of said slots.

In another aspect, there is provided a blade for a rotor of a gas turbine engine, the blade comprising an airfoil portion extending between a radially inward base and a radially outward tip; and a root attached to the radially inward base of the airfoil portion and extending along a generally axial length, the root having a cross-sectional size varying along the length of the root between a first root end and a second root end, wherein the root has a tapered shape with at least one dimension of a cross-sectional shape of the root decreasing along at least a portion of the length of the root, wherein the at least one dimension at the first root end is greater than the at least one dimension at the second root end.

In a further aspect, there is provided a method of forming a blade of a rotor of a gas turbine engine, the method comprising forming a tapered root of the blade with at least one dimension of a cross-sectional shape of the root progressively reducing along at least a portion of an axial length of the root, wherein the at least one dimension at a first root end is greater than the at least one dimension at a second root end.

### BRIEF DESCRIPTION OF THE DRAWINGS

Reference is now made to the accompanying figures in which:

FIG. 1 is a schematic cross-sectional view of a gas turbine engine;

FIG. 2 is a partial perspective view of a rotor of the gas turbine engine of FIG. 1 in accordance to a particular embodiment of the present disclosure, showing a disc having a single blade mounted thereto;

FIGS. 3A and 3B are schematic cross-sectional views of front and rear slot openings of each of the blade slots in the disc of the rotor of FIG. 2;

FIG. 4 is a schematic cross-sectional view of the rotor of FIG. 2; and

FIG. 5 is a partial perspective view of a shrouded rotor for the gas turbine engine of FIG. 1, in accordance to another particular embodiment.

### DETAILED DESCRIPTION

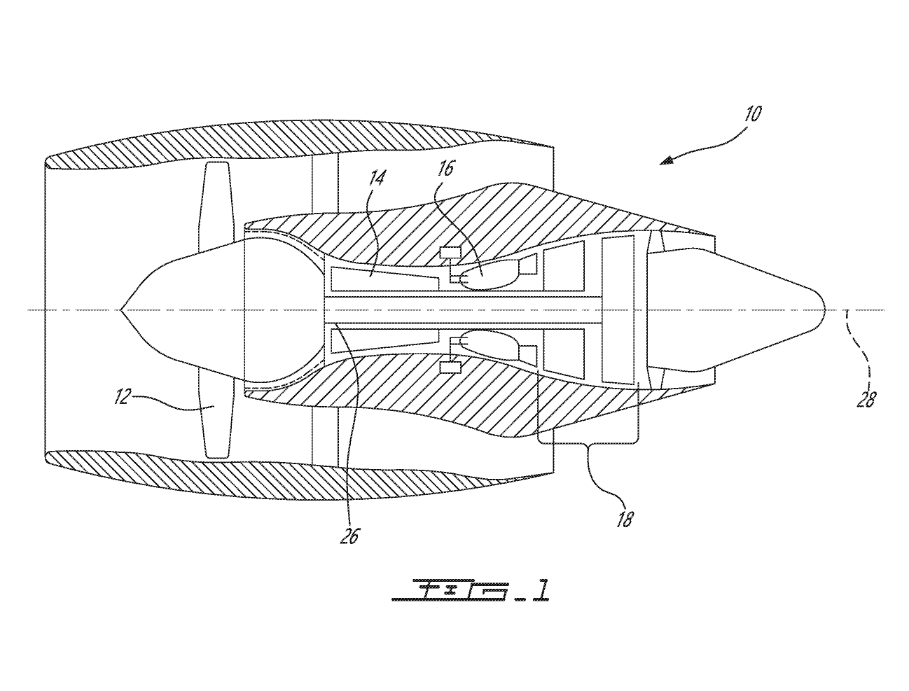

FIG. 1 illustrates a gas turbine engine 10 of a type preferably provided for use in subsonic flight, generally comprising in serial flow communication a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases.

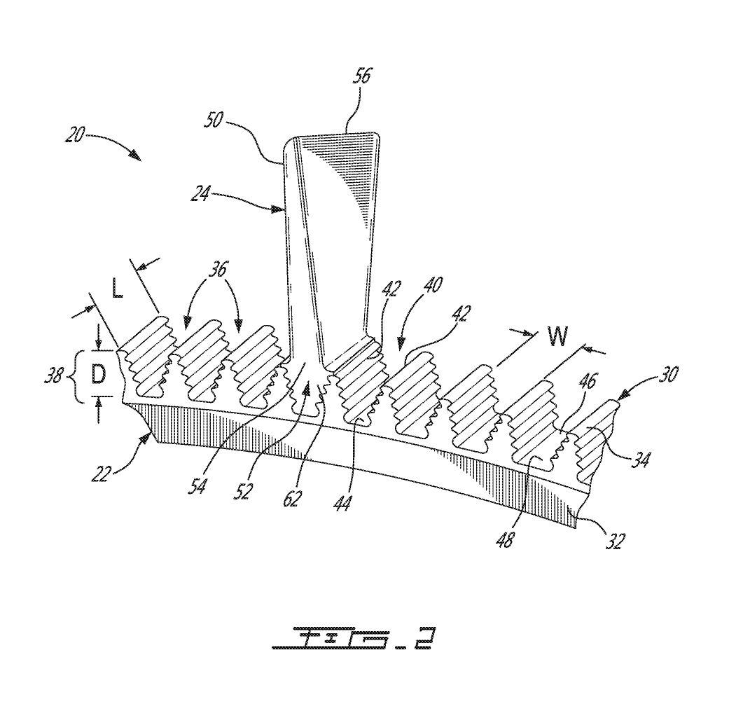

Referring to FIG. 2, a rotor 20 for the gas turbine engine 10 is partially shown. The rotor 20 can be any suitable component of the compressor section 14 or turbine section 18 which includes a rotor disc 22 (partially shown) and rotor blades 24 (only one is shown) surrounding and rotating with a shaft 26 along an axis 28 (FIG. 1) of the engine 10. In a particular embodiment, the rotor 20 forms part of an axial compressor disposed in an air passage of the compressor section 14. In an alternate embodiment, the rotor 20 forms part of an axial turbine disposed in a passage of the combustion gases for extracting the energy from the combustion gases in the turbine section 18.

The disc 22 has two opposite end surfaces 30, 32 which are axially spaced apart by a peripheral surface 34. The peripheral surface 34 circumferentially extends around the rotor 20. In a particular embodiment, the end surfaces 30, 32 are substantially parallel relative to each other and substantially perpendicular relative to the axis 28 of the engine 10. In a particular embodiment, the front end surface 30 is an upstream surface of the rotor 20 relative to a direction of the combustion gases in the turbine section 18. In an alternate embodiment, the rear end surface 32 is the upstream surface of the rotor 20 in the compressor section 14. Thus, in the compressor section 14, a differential pressure of the air across the compressor rotor acts on the front surface 30 of the rotor 20 and in the turbine section 18, a differential pressure of the combustion gases across the turbine rotor acts on the front surface 30 of the rotor 20. In other words, a force derived from the differential pressure across the rotor 20 acts on the front end surface 30 during the normal operation of the gas turbine engine 10.

The disc 22 includes a plurality of slots 36 defined in a peripheral portion such as a rim 38 thereof through the peripheral surface 34, each of the slots 36 extending between the end surfaces 30, 32 of the disc. In a particular embodiment, the slots 36 extend generally axially. In another particular embodiment, the slots can be slightly skewed relative to the axis 28 of the rotor 20. The slots 36 can be any suitable groove, opening and/or recess formed in the disc to receive a generally complementary portion of one of the blades 24 in order to thereby connect, secure and/or attach the blade 24 onto the disc 22. Each slot 36 defines a circumferential inlet 40 having a width W extending circumferentially between two opposite edges 42 of the inlet 40 in the peripheral surface 34, and extends radially inward from the inlet 40 to a depth D defined by a distance between the inlet 40 to a point 44 of the slot furthest from the inlet 40. Each slot 36 also extends through the rim 38 of the disc 22 between a front slot opening 46 defined in the front end surface 30 and a rear slot opening 48 defined in the rear end surface 32. The slots 36 can extends generally axially or slightly skewed relative to the axis 28 of the rotor 20. A length L of the slot is defined between the front and rear slot openings 46, 48. In a particular embodiment, the slots 36 are equally circumferentially spaced apart about the outer periphery of the disc 22.

Generally, the slots 36 have the same, substantially the same and/or similar cross-sectional shape. The shape of the slot 36 is tapered along the length L. In a particular embodiment, the cross-sectional shape varies in cross-sectional size along the length L thereof. Alternatively, the cross-sectional size can be maintained while tapering the slot 36. In the embodiment shown, the slots 36 have a tapered shape reducing in one dimension of the cross-sectional shape along the length L. Consequently, each of the slots 36, and thus each of the corresponding blade root received therein, have a cross-sectional shape that tapers from the front slot opening 46 to the rear slot opening 48, and therefore the front slot opening 46 defines a cross-sectional size that is larger than that of the opposed rear slot opening 48. Although in the embodiments shown the slot 36 is continuously tapered, in an alternate embodiment, the slot 36 can be discontinuously tapered. Thus the term “tapered” is not limited to progressive and uniform tapered shape. Alternately expressed, the term “taper” can also include a discrete reduction in cross-sectional size in which one or more portions of the slot 36 can be tapered along its length L while other portions maintain generally constant cross-sectional dimensions. The tapering of the slots 36 and of the blade roots accordingly means that the blade roots can only be inserted into the slots 36 from one of the two axial sides 30, 32 of the rotor disc 22.

To taper the shape of the slot 36, at least one dimension of the cross-sectional shape of the slot 36 is reduced at one side of the rotor relative to the other side of the rotor. Additional dimensions can also be reduced. In the embodiment shown, the width W of the slots 36 continuously decreases from one side of the slot to the other. In an alternate embodiment, the depth D of the slots continuously decreases. In yet another embodiment, the width W and the depth D are continuously decreased from one side of the slot to the other. In yet another alternate embodiment, one dimension can be reduced while another dimension is increased, for example, to maintain a substantially constant cross-sectional area over the length of the slot, even if one or more dimensions decrease over the length. In all cases, a tapered and/or wedged shape slot (and thus complimentary blade root) is thus provided, such that the blade root can be inserted and removed from only one side (i.e. that with the largest dimension(s)) of the slot.

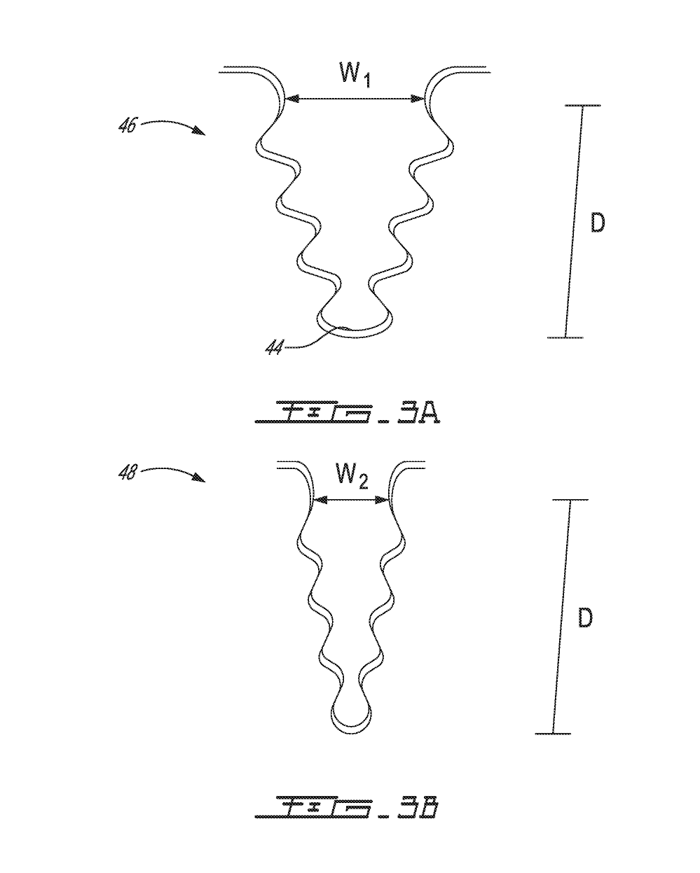

Referring to FIGS. 3A and 3B, the cross-sectional shape of the front and rear slot openings 46, 48 is shown. In this particular embodiment, the length L and depth D of the cross-sectional shape of the slot 36 are maintained while the width W of the cross-sectional shape is reduced such that the width W1 of the front slot opening 46 is larger than the width of the rear slot opening 48 W2 (W1>W2). It is understood than any other dimension of the cross-sectional shape can be reduced along any portion of the slot 36 to taper the slot 36.

The cross-sectional shape of each of the slots 36 in the rotor disc 33 can be any suitable geometrical profile. In the embodiment shown, the cross-sectional shape of the slots 36 and the complementary blade roots is a firtree profile. In an alternate embodiment, the cross-sectional shape may have a dovetail profile.

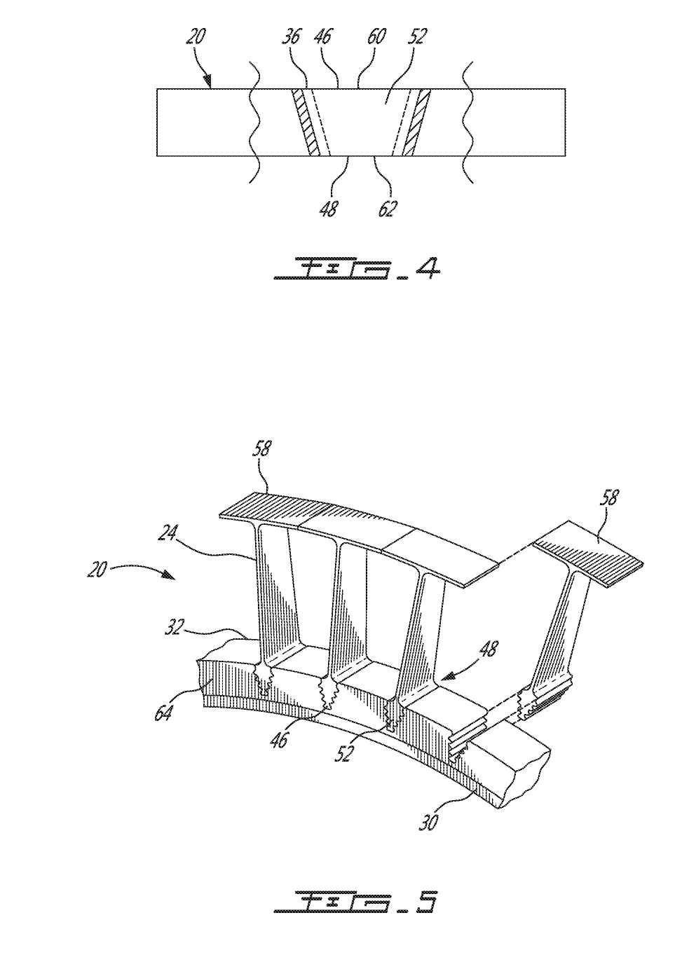

Referring back to FIG. 2, an airfoil portion 50 and a root 52 of the blade 24 is shown. The airfoil portion 50 extends between a radially inward base 54 and a radially outward tip 56. In the embodiment shown in FIG. 5, an alternate embodiment is shown with the radially outward tip 56 is attached to a shroud segment 58 interconnected to adjacent shroud segments 58 of adjacent blades 24 to form a shroud ring (partially shown) circumferentially surrounding the blades 24. In such an embodiment, the shroud ring can minimize blade vibration and fluid leakage at the tip 56 of the blades 24. The root 52 is attached to the radially inward base 54 of the airfoil portion 50 and extends along the length L of the disc 22 between a front root end 60 (FIG. 4) and a rear root end 62. In a particular embodiment, the roots 52 have the same, substantially the same and/or similar cross-sectional shape. In a particular embodiment, the cross-sectional shape varies in cross-sectional size along the length L thereof. Alternatively, the cross-sectional size can be maintained while tapering the root 52. In the embodiment shown, the root 52 has a tapered shape reducing in one dimension of the cross-sectional shape along the length L. Consequently, of the dimension at the front root end 60 is larger than the dimension at the rear root end 62. In a particular embodiment, the root 52 is continuously tapered between the two root ends 60, 62. The cross-sectional shape can be any suitable geometrical figure. In the embodiment shown, the cross-sectional shape is a fir-tree profile. In an alternate embodiment, the roots 52 have a dovetail cross-sectional profile.

Referring to FIG. 4, a top elevation cross-sectional view of the rotor 20 is shown. The root 52 of the blade 24 is received in the corresponding slot 36 of the disc 22. The root 52 has a shape and size conforming to the shape and size of the corresponding slot 36. The size of the root 52 is slightly smaller than the size of the slot 36 to allow the root 52 to slide within the slot 36 from the front slot opening 46 when connecting the blade 24 to the disc 22. Advantageously, the roots 52 are consequently self-locating in the axial direction, as the mating tapered profiles of the roots 52 and slots 36 result in the blades 24 only being able to slide axially in a single axial direction and only a given distance before no further axial displacement becomes possible. The root 52 is also shaped and sized to slide into the slot 36 through the front slot opening 46 and to be prevented from sliding through the rear slot opening 48 and therefor the root 52 will be blocked from sliding into the slot 36 through the rear slot opening 48.

Referring to FIG. 5, a retaining element 64 of the rotor 20 is partially shown. The retaining element 64 can be any suitable fastening structure, such as a retaining ring, to block the roots 52 of the blades 24 from moving or sliding in the axial direction by obstructing the front slot openings 46. Since the shape of the root 52 and the corresponding slot 36 is tapered, the retaining element 64 is advantageously only connected to only the front end surface 30. Thus, the rear slot openings 48 remain unobstructed. The blades 24 can therefore be precisely aligned in the axial direction, without requiring a retaining element on the rear end surface 32. The elimination of at least one set of retaining element 64 on the rotor 20 represents important weight and cost savings. In a particular embodiment, the retaining element 64 is an annular cover. The annular cover can include two or more arcuate segment that together form the annular cover. In an alternate embodiment, the retaining element 64 includes rivets attached to the front end surface 30. In the embodiment shown, the roots 52 are secured axially by the retaining ring (partially shown) riveted to the front end surface 30. The retaining ring extends over the front slot openings 46 of the slots 36 to trap the roots 52 of the blades 24 within their corresponding slots 36. In a particular embodiment, the retaining ring extends substantially fully over the front slot openings 46. In an alternate embodiment, the retaining ring extends partially over the front slot openings 46.

The slots 36 and the correspondingly conforming roots 52 are formed by varying the cross-sectional size along the axial length of the rotor 20. In a particular embodiment, the slots 36 and the roots 52 are shaped by electrical discharge machining (EDM), given the accuracy of the EDM machining process. Alternate machining processes can however alternately be used.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A rotor for a gas turbine engine comprising:
a disc having opposite first and second end surfaces axially spaced apart by a peripheral surface circumferentially extending about the rotor, a plurality of slots defined in the peripheral surface and each having a length in an axial direction extending between a first slot opening in the first end surface and a second slot opening in the second end surface, each of the plurality of slots having a tapered shape with at least one dimension of a cross-sectional shape of the slot progressively reducing along at least a portion of the length of the slot, wherein the at least one dimension at the first slot opening is greater than the at least one dimension at the second slot opening to define said tapered shape; and
a plurality of blades each having a root received in a respective one of said slots, the root having a complimentary shape and size to said respective one of said slots.

2. The rotor as defined in claim 1, wherein each of the plurality of slots extends axially between the first and second slot openings.

3. The rotor as defined in claim 1, wherein the at least one dimension is a width of the slot.

4. The rotor as defined in claim 1, wherein each of the plurality of slots is continuously tapered from the first slot opening to the second slot opening.

5. The rotor as defined in claim 1, wherein the first end surface is an upstream surface of the rotor relative to a direction of fluid flow of the gas turbine engine, the first slot opening being upstream of the second slot opening.

6. The rotor as defined in claim 1, wherein the second end surface is an upstream surface of the rotor relative to a direction of fluid flow of the gas turbine engine, the second slot opening being upstream of the first slot opening.

7. The rotor as defined in claim 1, wherein the cross-sectional shape has a firtree profile.

8. The rotor as defined in claim 1, wherein the cross-sectional shape has a dovetail profile.

9. The rotor as defined in claim 1, comprising at least one retaining element connected to only the first end surface and extending at least partially over the first slot opening of each slot to trap the roots of the blades within their corresponding slots, the second slot openings remaining unobstructed.

10. The rotor as defined in claim 1, wherein a cross-sectional area of each of the slots decreases from the first slot opening to the second slot opening.

11. A blade for a rotor of a gas turbine engine, the blade comprising:
an airfoil portion extending between a radially inward base and a radially outward tip; and
a root attached to the radially inward base of the airfoil portion and extending along a generally axial length, the root having a cross-sectional size varying along the length of the root between a first root end and a second root end, wherein the root has a tapered shape with at least one dimension of a cross-sectional shape of the root decreasing along at least a portion of the length of the root, wherein the at least one dimension at the first root end is greater than the at least one dimension at the second root end.

12. The blade as defined in claim 11, wherein the root is sized and configured to be received in a correspondingly-shaped and sized profile of a slot defined in a peripheral portion of the rotor.

13. The blade as defined in claim 11, wherein the root is continuously tapered from the first root end to the second root end.

14. The blade as defined in claim 11, wherein the root is configured to slide into a slot defined in a peripheral portion of the rotor through a first slot opening and is prevented to slide into the slot through a second slot opening.

15. The blade as defined in claim 11, wherein the at least one dimension is a width of the root.

16. The blade as defined in claim 11, wherein the root is continuously tapered from the first root end to the second root end, the at least one dimension decreasing continuously from the first root end to the second root end.

17. A method of forming a blade of a rotor of a gas turbine engine, the method comprising:
forming a tapered root of the blade with at least one dimension of a cross-sectional shape of the root progressively reducing along at least a portion of an axial length of the root, wherein the at least one dimension at a first root end is greater than the at least one dimension at a second root end.

18. The method as defined in claim 17, wherein forming the root of the tapered root includes continuously tapering the root between the first root end and the second root end.

19. The method as defined in claim 17, wherein forming the root of the blade includes shaping and sizing a profile of the root to correspondingly engage a slot defined in a peripheral portion of the rotor.

20. The method as defined in claim 17, wherein forming the root of the blade is performed through electrical discharge machining (EDM).
